(19) United States
(12) Patent Application Publication
(10) Pub. No.: US 2011/0258154 A1
(43) Pub. Date: Oct. 20, 2011

(54) CONTENT DURATION AND INTERACTION MONITORING TO AUTOMATE PRESENTATION OF MEDIA CONTENT IN A CHANNEL SHARING OF MEDIA CONTENT IN A CHANNEL

(75) Inventor: Patrick Ratnakanth Koppula, San Francisco, CA (US)

(73) Assignee: FFWD CORPORATION, San Francisco, CA (US)

(21) Appl. No.: 12/760,619

(22) Filed: Apr. 15, 2010

(51) Int. Cl. G06F 3/01; G06N 5/02

(52) U.S. Cl. 706/46; 715/719

(57) ABSTRACT

Disclosed are a method and system for content duration and interaction monitoring to automate presentation of media content in a channel sharing of media content in a channel. A method of generating a customized video channel comprises algorithmically generating in a computer a parameter based on an action of a web browser. In addition, the method algorithmically determines an association between the parameter and a video content, and updating a list of video content of the customized video channel with the video content. The method may also comprise algorithmically creating an additional parameter based on another action of another web browser, and algorithmically associating the additional parameter with another video content.

### FIELD OF TECHNOLOGY

This disclosure relates generally to providing media content via a computer network and more particularly to a method and system of automatically creating a customized media channel.

### BACKGROUND

A user may access a video website to view a video. The user may want to view a particular video. The video website may include a database of searchable video content. The user may utilize a search engine to search the database for the particular video. The search engine may not be an optimal method of providing the user with sufficiently engaging video content. For example, the search engine may return a number of videos that are not relevant to the particular video the user wants to view. The user may have to review the number of videos to locate the particular video. The user may consider the review of irrelevant videos as a waste of time. The user may navigate away from the video website.

Additionally, the video website may employ channel programmers to create additional video channels. Furthermore, the channel programmers may increase the cost of operating the video website. For example, the video channel may be populated with a number of video clips. A channel programmer may be required to watch each video clip in order to make a determination of whether to include it into a type of video channel. At the same time, the total number of video clips in the data base may increase. A video content provider may need to employ an additional number of video programmers. Consequently, the cost of to the video content provider may increase. The increase in cost may lead to the creation and maintenance of fewer video channels. Fewer available video channels may decrease the amount of video content available to users. Consequently, the total number of users of the video website may decrease. The video website may not be able to attract advertising and/or subscription revenue.

### SUMMARY

Several methods and a system for content duration and interaction monitoring to automate presentation of media content in a channel sharing of media content in a channel are disclosed. An exemplary embodiment provides a method of generating a customized video channel. The method includes algorithmically generating in a computer a parameter based on an action of a web browser. An association between the parameter and a video content is algorithmically determined. A list of video content of the customized video channel is updated with the video content.

An exemplary embodiment provides a system of a video content provider. The system includes a server to run a software application of the video content provider. The system includes a database. In addition, a parameter module algorithmically generates a parameter based on an action of a web browser. A associator module algorithmically determines an association between the parameter and a video content. A customizer module updates a list of video content of the customized video channel with the video content.

An exemplary embodiment provides a computer-implemented method of programming a customized video channel. The method includes algorithmically generating in a computer a parameter based on an action pertaining to a video content. The action is associated with a video channel comprising a particular genre of video content. The video channel is included a list of video content of the customized video channel.

Other aspects and example embodiments are provided in the drawings and the detailed description that follows.

### BRIEF DESCRIPTION OF THE VIEWS OF DRAWINGS

Example embodiments are illustrated by way of example and not limitation in the figures of the accompanying drawings, in which like references indicate similar elements and in which:

FIG. 1 is a system view of a network including a customize video channel server according to one embodiment.

FIG. 2 illustrates generation and updating of video channel according to one embodiment.

FIG. 3 is a schematic view a web page retrieved from the customize video channel server according to one embodiment.

FIG. 4 is a table view illustrating various fields such as an action with a web browser, a generated parameter, a video content associated with the parameter, and an update to user's customized channel, etc according to one embodiment.

FIG. 5 is a diagrammatic system view of a data processing system in which any of the embodiments disclosed herein may be performed according to one embodiment.

FIG. 6A is a process flow of generating a customized video channel.

FIG. 6B is a continuation of process flow of FIG. 6A illustrating additional operations according to one embodiment.

FIG. 7 is a process flow of a computer-implemented method of programming a customized video channel according to one embodiment.

Other features of the present embodiments will be apparent from the accompanying drawings and from the detailed description that follows.

### DETAILED DESCRIPTION

Several methods and a system for content duration and interaction monitoring to automate presentation of media content in a channel sharing of media content in a channel are disclosed. Although the present embodiments have been described with reference to specific example embodiments, it will be evident that various modifications and changes may be made to these embodiments without departing from the broader spirit and scope of the various embodiments.

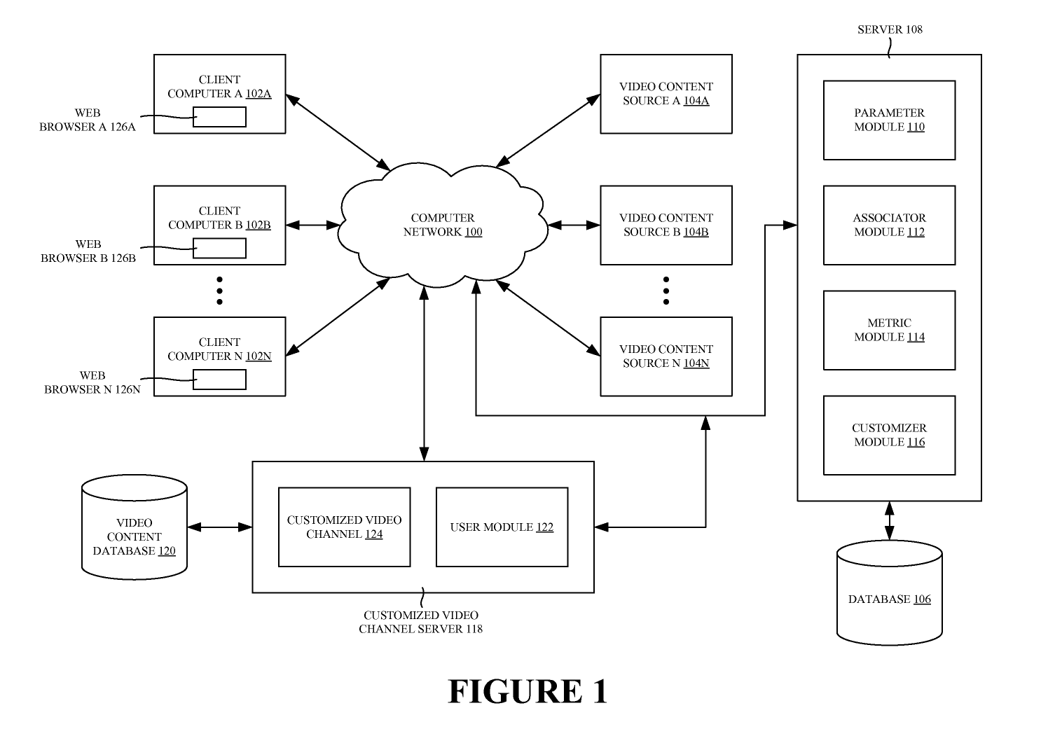

FIG. 1 is a system view of a network including a customized video channel server 118. Particularly, FIG. 1 illustrates a computer network 100, a number of client computers 102A-102N, a number of video content sources 104A-104N, a database 106, a server 108, a customized video channel server 118 and a video content data base 120. In other embodiments, the media content may not be limited to video content. The media content may include any electronic digital media such as text, audio, video or image content. A user may utilize the client computer 102A-102N to access the computer network 100. The client computer 102A-102N may be a general purpose personal computer that operates a web browser. The web browser may be a software application which enables the user to display and interact with text, images, videos, music, games and other information located on a Web page at a Web site supported by the server 108. The Web site may be available via the computer network 100. The client computer 102A-102N may be associated with the computer network 100. The computer network 100 may include a group of interconnected computers. The client computer 102A-102N may be communicatively coupled to a computer network 100. For example, the computer network 100 may include a Wide Area Network (WAN) that uses routers and public communications links. The computer network 100 may include the Internet. Data may be interchanged over the computer network by packet switching using a standardized protocol (e.g. Internet Protocol Suite). In other embodiments, the computer network 100 may include a cloud computing components such as cloud infrastructure, data centers, platform virtualization and servers provisioned from a third-party enterprise.

The computer network 100 may be associated with at least one video content source 104A-104N. The video content source 104A-104N may include a media content provider (e.g. HBO®, Netflix®, YouTube®, Disney®, ABC®, Fox®, Blockbuster®), a multiple services operator (MSO) electronically converted speech (e.g. a Skype® call) an email, a text message, an instant message (IM), a telephone call, a recorded conversation, a blog, a micro-blog, a chatroom discussion, a social networking site (e.g. Myspace®, Facebook®), a precreated feed (e.g. Yahoo ®media, Google News®), a community based news article site (e.g. Yahoo Buzz®, Digg®), a review site (e.g. Yelp®, Rottentomatoes®, IMDB®, Gayot®, Zagat®, the Michelin Guide®), a news site (e.g. CNN®, NY Times®, CNET®, ABC®), an online reference (e.g. Wikipedia®, the Urban Dictionary®, Dictionary.com®, Thesaurus.com®) and a community-based news referral (e.g. Digg®). The customized video channel server 118 may identify a trending term on the video content source 104A-104N. The server 108 may interpret the trending term and determine a media attribute associated with the trending term. The server 108 may update a channel of the Web page with content that includes the media attribute.

The recommendation engine server 108 may include an application server dedicated to running a set of software applications that provide media content via the computer network 100. Specifically, the server 108 may include a parameter module 110, an associator module 112, a monitor module 114, and a customizer module 116. The server 108 may include an application program interface (API). The API may include a set of set of functions, procedures, methods, classes and protocols that support media content requests made by the client computer 102A-102N. The server 108 may include more than one application server. The server 108 may locate and save video content (or other media content data) and related metadata from the video content source 104A-104N. The server 108 may save the video content to a data base 106. In other embodiments, the server 108 may store a location of the video content, related metadata and data pertaining to the associated video content source 104A-104N. The server 108 may then embed the video content into the Web page and present a compound document on the Web site. The data base 104 may store other data relevant to other functions and operations of the server 108.

The parameter module 110 may be a software functionality and/or hardware circuit that algorithmically generates a parameter based on an action of a web browser. The web browser may be a software application which enables the user to display and interact with text, images, videos, music, games and other information typically located on a Web page at a Web site on the World Wide Web or a local area network. The action may be a non-random user behavior that conveys an intent to view a particular video content type. For example, the action may be, inter alia, a subscription to a particular video channel; a viewing of at least one of a particular pre-programmed video channel and a particular video type; a time period of viewing a particular video content; a specified period of time indicated by a user; and a fast forwarding action. The parameter may define a characteristic of the action.

The parameter module 110 may also algorithmically create an additional parameter based on another action of another web browser. The other action may be performed by another user with a web browser while accessing the customized video content Web site. The additional parameter may define a characteristic of the other action. The parameter module 110 may algorithmically ascertain a correlation between the action and the other action.

The associator module 112 may be a software functionality and/or hardware circuit that algorithmically determines an association between the parameter and a video content. The associator module 112 may also algorithmically associate the additional parameter with another video content. For example, a user may perform the action of subscribing to a cricket highlights component channel. The parameter module 110 may then generate a parameter to include another cricket related component channel in the user's customized channel. The parameter module 110 may then associate the parameter with an component channel titled “Cricket Worldwide” that displays international cricket match highlights.

The customizer module 116 may be a software functionality and/or hardware circuit that updates a list of video content of a customized video channel with the video content. The customizer module 116 may include the other video content in the list of video content of the customized video channel. The customizer module 116 may embed the customized video channel into the customized video content web page. The embedding operation may create a compound web page that includes text document intermingled with non-text elements such as spreadsheets, pictures, digital videos, digital audio, and other multimedia features.

The metric module 114 may monitor a value of the association between the parameter and the video content according to a specified metric.

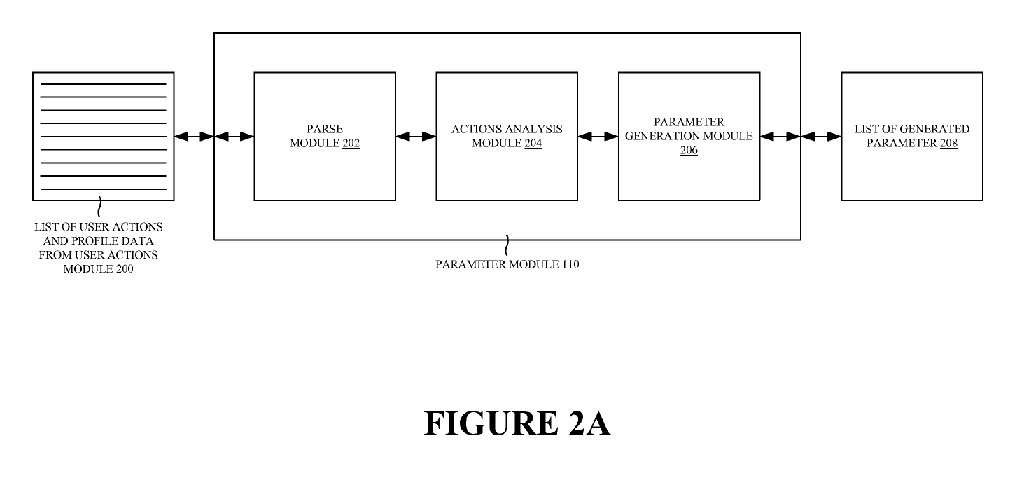

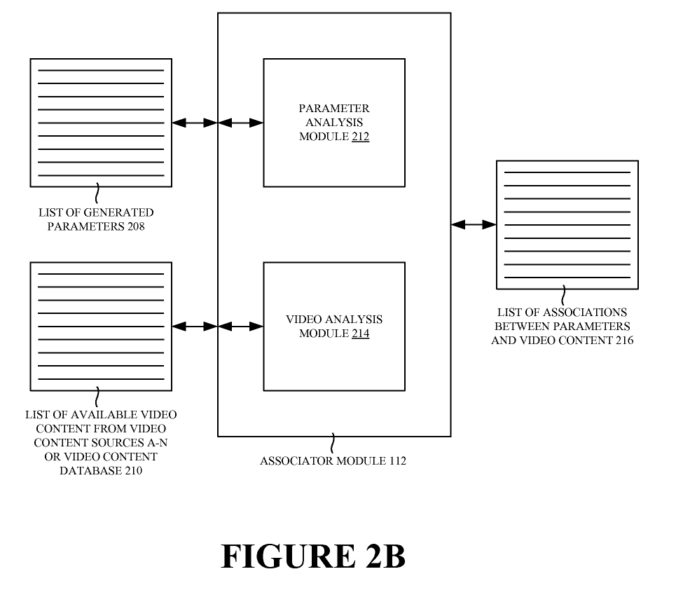

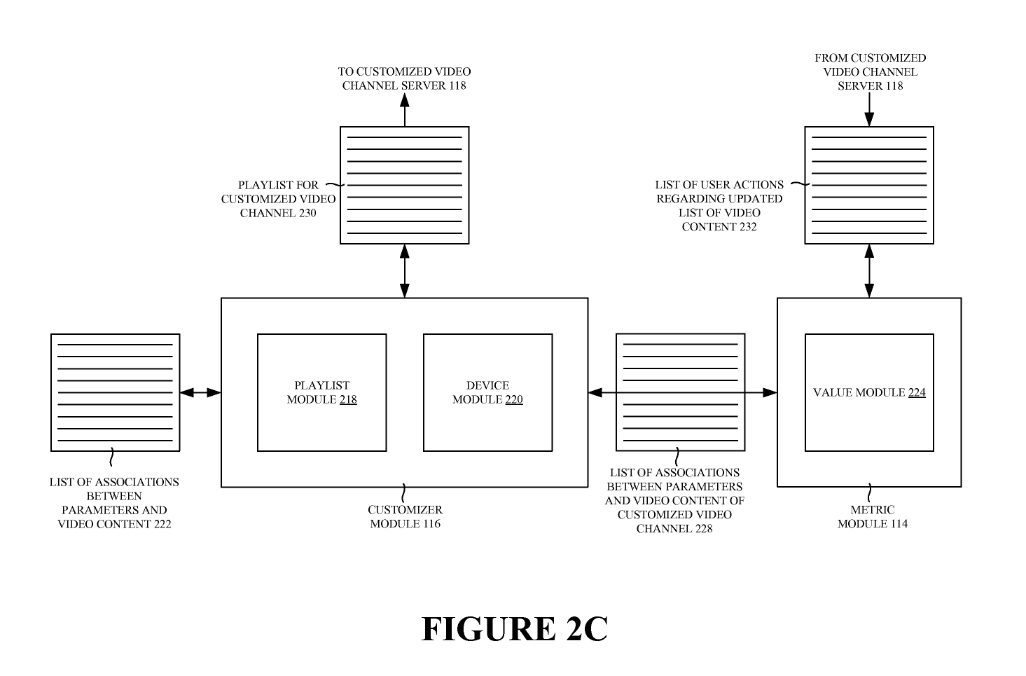

FIG. 2 illustrates generation and updating of video channel. FIG. 2A illustrates generation of a list of parameters. In particular, FIG. 2A illustrates a list of user actions and profile data from user actions module 200, a parse module 202, an action analysis module 204, a parameter generation module 206 and a list of generated parameter 208, according to one embodiment. The list of user actions and profile data from the user actions module may be received by the server 108. The parameter module 110 may then use the list of user actions and profile data from the user action module to generate a list of parameters 208. The parameter module 110 may include the parse module 202, the action analysis module 204, and the parameter generation module 206. The parse module 202 may use the list of user actions and profile data to analyze the information to enable the parameter generation module 206 to generate some specific parameters. The action analysis module 204 may analyze the user actions from the user actions module to enable the parameter generation module 206 to generate parameters based on the user action. The parameter generation module 206 may then generate the list of parameters based on the input from the parse module 202 and the action analysis module 204.

FIG. 2B illustrates generation of a list of associations between the generated parameters and the video content 216. The list of generated parameters 208 generated from the parameter module 110 may be provided as an input to the associator module 112. The associator module 112 may also take input from a list of available video content from video content sources A-N or video content database 210. The list of available video content from video content sources A-N or video content database 210 may be provided by the customized video channel server 118. The associator module 112 may include a parameter analysis module 212 and a video analysis module 214. The parameter analysis module 212 may analyze the list of generated parameters 208 to enable the associator module 112 to generate an association between parameter and the video content analyzed by the video analysis module 214. The video analysis module 214 may analyze the list of available video content from the video sources A-N or the video content database 210 to enable the associator module 112 to associate with the analyzed matter of the generated parameters 208. The associator module 112 may then generate a list of associations between parameters and video content 216.

FIG. 2C illustrates generation of a video channel and its updating based on generated associations between the parameters and video content. The list of associations between the parameters and video content 222 may be an input to the customizer module 116. The customizer module 116 may generate a playlist for customized video channel 230. The playlist for customized video channel 230 may be generated using the assistance of the playlist module 218 and the device module 220 of the customizer module 116. The generated playlist for the customized video channel 230 may be communicated to the customized video channel server 118. The customized video channel server 118 may communicate back to the server 108 with a list of user actions regarding updated list of video content 232. The value module 224 may be configured to take the generated list by the customized channel server 118 as an input. The value module 224 may be a part of the metric module 114. The metric module 114 may monitor a value of the association between the parameter and the video content according to a specified metric. The customizer module 116 and the metric module 114 may communicate with each other.

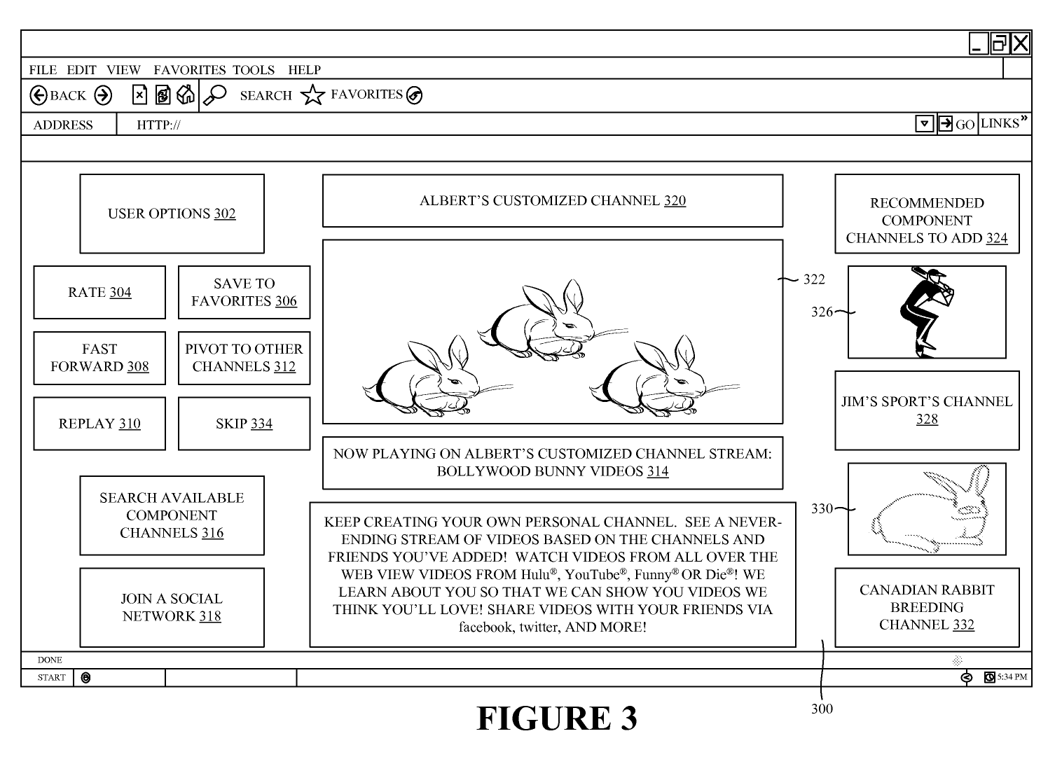

FIG. 3 is a schematic view a web page 300 retrieved from the customized video channel server 118. In particular, FIG. 3 illustrates user options 302, a rate option 304, a save to favorites option 306, a fast forward option 308, a replay option 310, a pivot to other channels option 312, a title bar 314, a search channels option 316, join a social network option 318, channel title bar 320, media window 322, recommendation option 324, and recommended channel options 326-332, according to one embodiment.

The user options 302 may be a hyperlink that may enable the user to customize settings for the channel based on the preference of the user. In another embodiment, the user options 302 may be a drop down menu. The rate option 304 may enable the user to rate the media content. The save to favorites option 306 may enable the user to save the video content in a favorite list of the user. The fast forward option 308 may enable the user to advance the play of the video content rapidly. The replay option 310 may enable the user to replay the video content routed through the channel. The pivot to other channels option 312 may enable the user to move to other channels of the users choice. The other channels may include content associated with the video content presented in the media window 322.

The title bar 314 may illustrate the information associated to the media content that is being transmitted in the channel. The search channels option 316 may enable the user to search for component channels stored in the database 106. The join a social network option 318 may navigate the user to membership webpage of a social network. The channel title bar 320 may display the title and other related information associated with the video channel displayed in the media window 322. The media window 322 may be a location on a graphical user interface that displays the video content (as well as other related media content such as audio and image files). The video content may be a video stream that is constantly received by and presented to the web page 300 while it is being delivered by a third-party streaming provider The recommendation option 324 may recommend a component channel of the channel provider based on the search criteria of the user. The recommended channel options 326-332 may be sample component channels and information associated with the sample component channels. For example, component channel 326 may be “Jim's sport channel” 328 and component channel may be a “Canadian rabbit breeding” component channel 330.

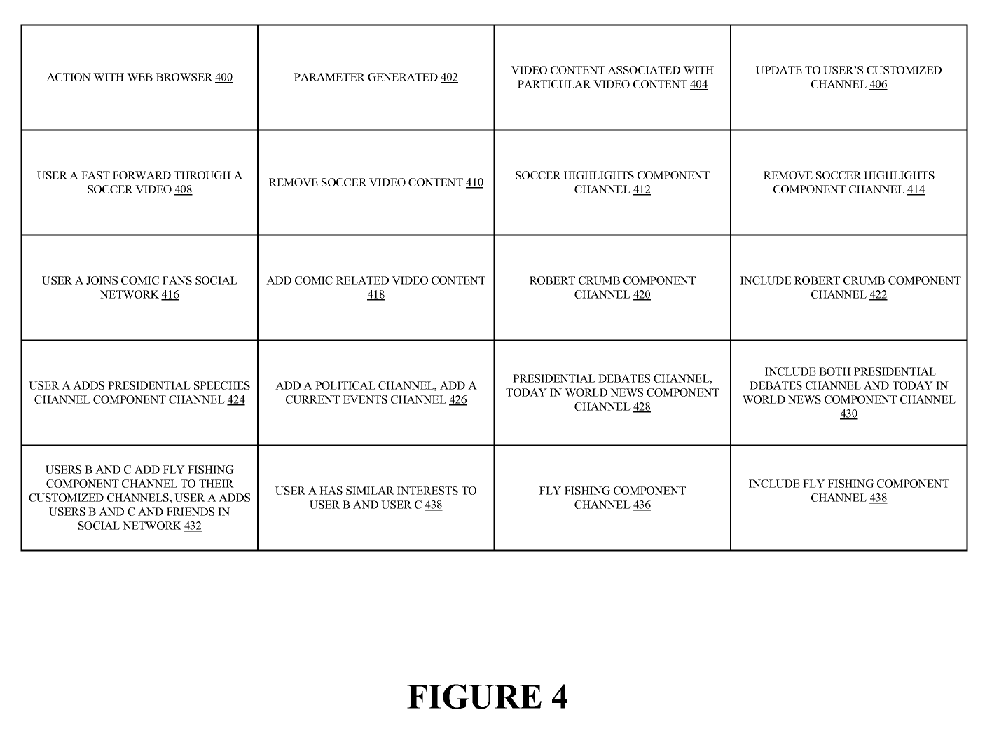

FIG. 4 is a table view illustrating various fields such as an action with a web browser, a generated parameter, a video content associated with the parameter, and an update to user's customized channel, etc. In particular, FIG. 4 illustrates an action with web browser field 400, a parameter generated field 402, a video content associated with parameter field 404, and update to user's customized channel field 406, according to one embodiment.

The action with web browser 400 field illustrates possible actions that a user may perform with the browser. The parameter generated field 402 may illustrate the generated parameter based on the action of the user with the browser as in field 400. The video content associated with parameter 404 field may illustrate the video content that may be captured by the channel provider based on the parameter generated by action of the user with web browser. The update to user's customized channel field 406 illustrates the customization action that the user may perform after evaluating the media content of the customized channel 124.

In example embodiment, a user ‘A’ may perform fast forward action through a soccer component channel 408 in the web browser. The parameter module 110 may algorithmically generate a parameter “remove soccer video content” 410. The video content that is algorithmically associated with the parameter “remove soccer video content” 410 by the associator module 112 may be a “soccer highlights component channel” 412. The customizer module 116 may remove the soccer highlight component channel from the list of component channels of the customized channel 124. User ‘A’ may join a comic fans social network 416. The parameter module 110 may algorithmically generate a parameter “add comic related video content” 418. The video content that is algorithmically associated by the associator module 112 with the parameter “add comic related video content” 418 may be a “Robert Crumb component channel” 420. The customizer module 116 may include the “Robert Crumb component channel” 420 to the list of component channels of the customized channel 124. User ‘A’ may add a presidential speeches component channel 424. The parameter module 110 may algorithmically generate a parameter of “add a political channel, add a current events channel” 426. The video that is algorithmically associated by the associator module 112 with the field 426 may be the “presidential debates channel” component channel and the “today in world news channel” component 428. The customizer module 116 may update the channel by including both “presidential debates component channel” and the “today in world news channel” 430 to the list of component channels of the customized channel 124. Users ‘B’ and ‘C’ may add a fly fishing component channel to their respective customized channels. In addition, user ‘A’ may add user ‘B’ and user ‘C’ as friends in a social network 432. The parameter module 110 may algorithmically generate the parameter “user A has similar interests to user B and user C” 438. The video content algorithmically associated by the associator module 112 with the parameter illustrated in field 438 may be a “fly fishing component channel” 436. The customizer module 116 may include the “fly fishing component channel” 436 to the list of component channels of the customized channel 124.

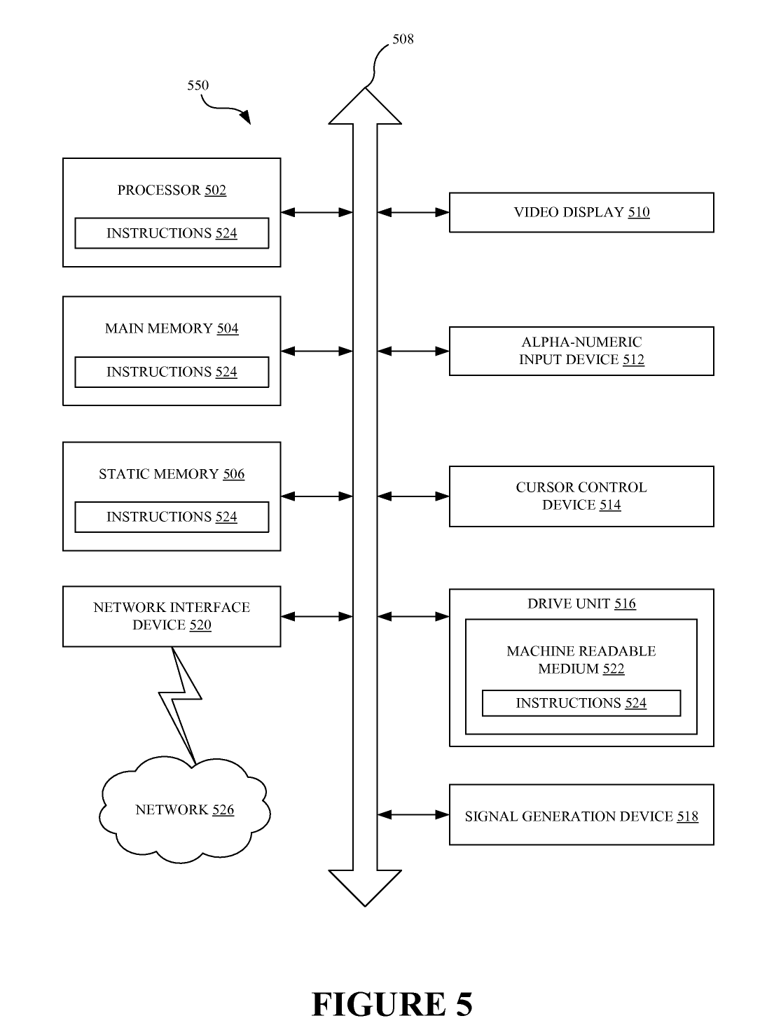

FIG. 5 is a diagrammatic system view of a data processing system in which any of the embodiments disclosed herein may be performed, according to one embodiment. Particularly, the diagrammatic system view 500 of FIG. 5 illustrates a processor 502, a main memory 504, a static memory 506, a bus 508, a video display 510, an alpha-numeric input device 512, a cursor control device 514, a drive unit 516, a signal generation device 518, a network interface device 520, a machine readable medium 522, instructions 524, and a network 526, according to one embodiment.

The diagrammatic system view 500 may indicate a personal computer and/or the data processing system in which one or more operations disclosed herein are performed. The processor 502 may be a microprocessor, a state machine, an application specific integrated circuit, a field programmable gate array, etc. (e.g., Intel® Pentium® processor). The main memory 504 may be a dynamic random access memory and/or a primary memory of a computer system.

The static memory 506 may be a hard drive, a flash drive, and/or other memory information associated with the data processing system. The bus 508 may be an interconnection between various circuits and/or structures of the data processing system. The video display 510 may provide graphical representation of information on the data processing system. The alpha-numeric input device 512 may be a keypad, a keyboard and/or any other input device of text.

The cursor control device 514 may be a pointing device such as a mouse. The drive unit 516 may be the hard drive, a storage system, and/or other longer term storage subsystem. The signal generation device 518 may be a bios and/or a functional operating system of the data processing system. The network interface device 520 may be a device that performs interface functions such as code conversion, protocol conversion and/or buffering required for communication to and from the network 526. The machine readable medium 522 may provide instructions on which any of the methods disclosed herein may be performed. The instructions 524 may provide source code and/or data code to the processor 502 to enable any one or more operations disclosed herein.

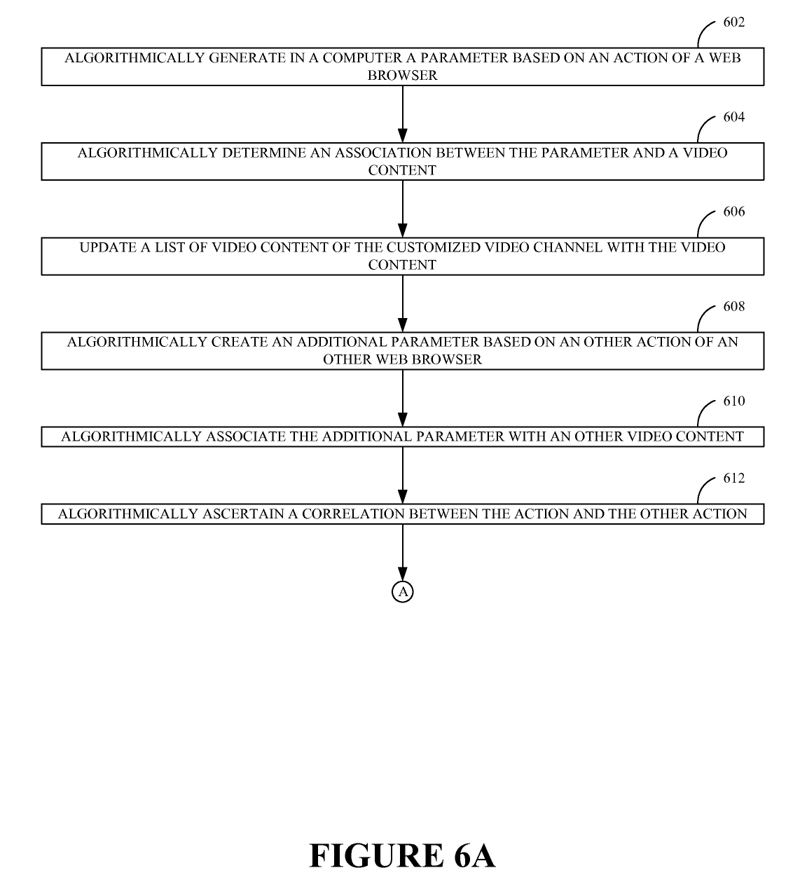

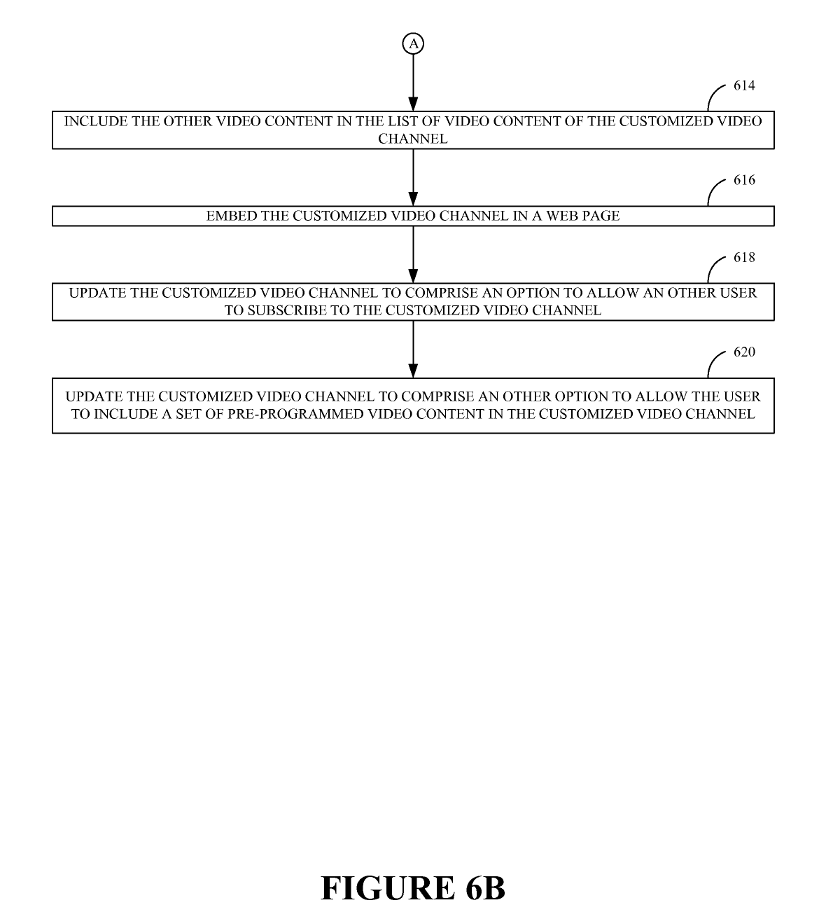

FIG. 6A is a process flow of generating a customized video channel 124, according to one embodiment. In operation 602, the customized video channel 124 may be algorithmically generated in a computer a parameter based on an action of a web browser. In operation 604, the customized video channel 124 may be algorithmically determined an association between the parameter and a video content. In operation 606, a list of video content of the customized video channel may be updated with the video content. In operation 608, an additional parameter may be algorithmically created based on another action of another web browser. In operation 610, the additional parameter may be algorithmically associated with another video content. In operation 612, a correlation between the action and the other action may be algorithmically ascertained.

FIG. 6B is a continuation of process flow of FIG. 6A illustrating additional operations, according to one embodiment. In operation 614, the other video content may be included in the list of video content of the customized video channel. In operation 616, the customized video channel may be embedded in a web page. In operation 618, the customized video channel to comprise an option may be updated to allow another user to subscribe to the customized video channel. In operation 620, the customized video channel to comprise another option may be updated to allow the user to include a set of pre-programmed video content in the customized video channel.

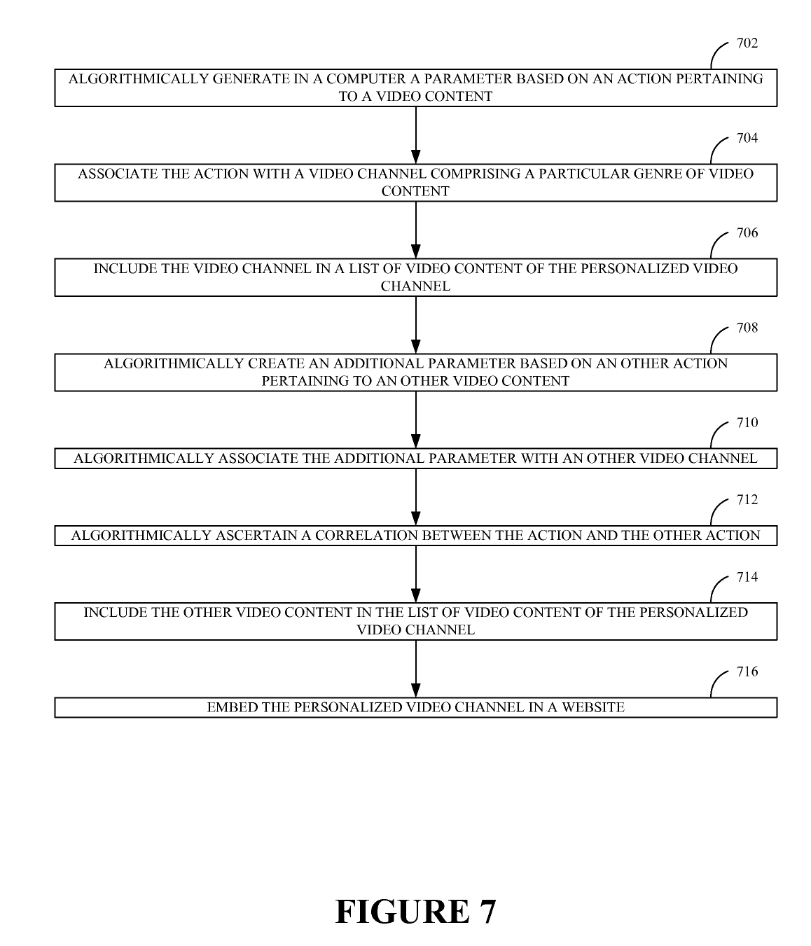

FIG. 7 is a process flow of a computer-implemented method of programming a customized video channel, according to one embodiment. In operation 702, the customized video channel 124 is algorithmically generated in a computer a parameter based on an action pertaining to a video content. In operation 704, the action may be associated with a video channel comprising a particular genre of video content. In operation 706, the video channel may be included in a list of video content of the customized video channel. In operation 708, an additional parameter may be algorithmically created based on another action pertaining to another video content. In operation 710, the additional parameter may be algorithmically associated with another video channel. In operation 712, a correlation between the action and the other action may be algorithmically ascertained. In operation 714, the other video content may be included in the list of video content of the customized video channel. In operation 716, the customized video channel may be embedded in a web page.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry, firmware, software and/or any combination of hardware, firmware, and/or software (e.g., embodied in a machine readable medium). For example, the various electrical structure and methods may be embodied using transistors, logic gates, and electrical circuits.

Particularly, parameter module 110, associator module 112 and the customizer module 116 of FIG. 1, may be enabled using software and/or using transistors, logic gates, and electrical circuits such as a health vault circuit, a personal communication circuit, a healthcare provider circuit, a dispatch circuit, a first responder circuit, and other circuit.

In addition, it will be appreciated that the various operations, processes, and methods disclosed herein may be embodied in a machine-readable medium and/or a machine accessible medium compatible with a data processing system, and may be performed in any order. Accordingly, the specification and drawings are to be regarded in an illustrative rather than a restrictive sense.

What is claimed is:

1. A method of a customized video channel comprising:
algorithmically generating in a recommendation engine server a parameter based on an analysis of an action of a user with a web browser while accessing the video channel;
algorithmically determining in a recommendation engine server an association between the parameter and a video content;
updating a list of video content of the customized video channel with the video content; and
monitoring a value of the association between the parameter and the video content according to a specified metric.
revising the list of video content of the customized video channel if a certain threshold of the specified metric fails to be attained.

2. The method of claim 1 further comprising:
algorithmically creating an additional parameter based on an other action of an other web browser; and
algorithmically associating the additional parameter with an other video content.

3. The method of claim 2 further comprising;
algorithmically ascertaining a correlation between the action and the other action.

4. The method of claim 3 further comprising: update
including the other video content in the list of video content of the customized video channel.

5. The method of claim 4 further comprising:
embedding the customized video channel in a web page.

6. The method of claim 5 further comprising:
determining the video content according to a specified period of time indicated by the user.

7. The method of claim 6 further comprising:
updating the customized video channel to comprise an option to allow an other user to subscribe to the customized video channel; and
updating the customized video channel to comprise an other option to allow the user to include a set of pre-programmed video content in the customized video channel.

8. The method of claim 7:
further comprising determining a non-random user behavior that conveys an intent to view a particular video content type to be an action, and
wherein the specified metric is at least one of a specified number of views of a particular video content and a specified period of time of viewing the particular video content.

9. The method of claim 8, wherein the action and the other action comprise at least one of:
a subscription to a particular video channel;
a viewing of at least one of a particular pre-programmed video channel and a particular video type;
a time period of viewing a particular video content; and
a fast forwarding action.

10. The method of claim 1, wherein a machine is caused to perform the method of claim 1 when a set of instructions in a form of a machine-readable medium is executed by the machine.

11. A system of a video content provider comprising:
a recommendation engine server;
a database to store a data of associated with a user;
a parameter module of the recommendation engine server algorithmically generate in a recommendation engine server a parameter based on an analysis of an action of the user with a web browser while accessing a video channel;
an associator module of the recommendation engine server to algorithmically determine an association between the parameter and a video content;
a metric module to monitor a value of the association between the parameter and the video content according to a specified metric; and
a customizer module to update a list of video content of the customized video channel with the video content if a certain threshold of the specified metric is attained and to revise the list of video content of the customized video channel if a certain threshold of the specified metric is attained.

12. The system claim 11:
wherein the parameter module algorithmically creates an additional parameter based on an other action of an other web browser; and
wherein the associator module algorithmically associates the additional parameter with an other video content.

13. The system of claim 12, wherein the parameter module algorithmically ascertains a correlation between the action and the other action.

14. The system of claim 13, wherein the customizer module includes the other video content in the list of video content of the customized video channel.

15. The system of claim 14, wherein the customizer module embeds the customized video channel into a web page.

16. The system of claim 15, wherein algorithmically determining an association between the parameter and the video content comprises:
determining the video content according to a specified period of time indicated by the user.

17. The system of claim 16, wherein the action with the web browser comprises associating the user with a social networking community.

18. The system of claim 17, wherein the action and the other action comprises at least one of:
a subscription to a particular video channel;
a viewing of a particular video type;
a time period of viewing a particular video content; and
a fast forwarding action.

19. A computer-implemented method of algorithmically programming a personalized video channel comprising:
algorithmically generating in a computer a parameter based on the action pertaining to a video content;
associating the action with a video channel comprising a particular genre of video content;
including the video channel in a list of video content of the personalized video channel.

20. The method of claim 19:
algorithmically creating an additional parameter based on an other action pertaining to an other video content; and
algorithmically associating the additional parameter with an other video channel;
algorithmically ascertaining a correlation between the action and the other action;
including the other video content in the list of video content of the personalized video channel; and
embedding the personalized video channel in a web page.
